(19) United States
(12) Patent Application Publication
(10) Pub. No.: US 2021/0031489 A1
(43) Pub. Date: Feb. 4, 2021

(54) COMPOSITE MATERIAL AND MANUFACTURING METHOD THEREOF, AND ELECTRONIC DEVICE

(71) Applicants: Han-Ching Huang, Taipei City (TW); Jung-Chin Wu, Taipei City (TW); Kuo-Nan Ling, Taipei City (TW); Po-An Lin, Taipei City (TW)

(72) Inventors: Han-Ching Huang, Taipei City (TW); Jung-Chin Wu, Taipei City (TW); Kuo-Nan Ling, Taipei City (TW); Po-An Lin, Taipei City (TW)

(73) Assignee: COMPAL ELECTRONICS, INC., Taipei City (TW)

(21) Appl. No.: 16/658,134

(22) Filed: Oct. 20, 2019

(30) Foreign Application Priority Data
Aug. 2, 2019 (TW) 108127541

(51) Int. Cl. B32B 7/027; B32B 7/12; B32B 7/022; B32B 27/12; B32B 27/08; B32B 27/16

(52) U.S. Cl. CPC B32B 7/027; B32B 7/12; B32B 7/022; B32B 2260/023; B32B 27/08; B32B 27/16; B32B 2457/00; B32B 27/12

(57) ABSTRACT

The present disclosure provides a composite material including a first thermoplastic adhesive layer made of a first thermoplastic resin, a second thermoplastic adhesive layer made of a second thermoplastic resin, and a core layer. The core layer has a first surface and a second surface, wherein the first surface is bonded to the first thermoplastic adhesive layer, and the second surface is bonded to the second thermoplastic adhesive layer. The core layer has a plurality of cavities, wherein each of the plurality of cavities has a pore diameter smaller than a thickness of the core layer. The first thermoplastic resin and the second thermoplastic resin are respectively adapted to be filled in a part of the plurality of cavities adjacent to the first surface of the core layer and a part of the plurality of cavities adjacent to the second surface of the core layer by heating.

### CROSS-REFERENCE TO RELATED APPLICATION

This application claims the priority benefit of Taiwan application serial no. 108127541, filed on Aug. 2, 2019. The entirety of the above-mentioned patent application is hereby incorporated by reference herein and made a part of this specification.

### BACKGROUND OF THE DISCLOSURE

### Field of the Disclosure

The present disclosure relates to a composite material and a manufacturing method thereof and in particular relates to a composite material suitable for an electronic device and a manufacturing method of the composite material.

### Description of Related Art

In recent years, electronic devices have become essential and important products in human life. With the development of technologies, functions and speeds of the electronic devices are continuously increased, and the electronic devices are developed from large machines with large volumes at the early stage to various portable electronic devices such as desktop computers, notebook computers, tablet personnel computers, smartphones, personal digital assistants and electronic books.

Two key requirements for the electronic devices lie in volume reduction and weight reduction. Micro-electronic components in the electronic devices will be researched and developed towards the trend, in addition, the selection for casing materials of the electronic devices is also an emphasis of the current development. In recent years, with the rise of environment protection awareness, the electronic devices have tend to adopt a relatively novel material such as a thermoplastic material or a glass fiber and a carbon fiber instead of a thermosetting material difficult to recover as a machine casing. However, the strength of the thermoplastic material is obviously insufficient, while the cost of the carbon fiber is too high and the carbon fiber does not meet the demands for strength and lightweight of a product. Therefore, for the machine casing made of the composite material, there is still a space for improving the mechanical strength and weight.

### SUMMARY OF THE DISCLOSURE

The present disclosure provides a composite material and a manufacturing method thereof, and an electronic device, wherein the composite material shows excellent mechanical strength and achieves a lightweight effect so as to be adapted to an electronic device. In addition, due to the use of a thermoplastic material, the composite material also has the characteristic of easy recovery, and therefore, the aim of environment protection is achieved.

The present disclosure provides a composite material comprising a first thermoplastic adhesive layer, a second thermoplastic adhesive layer and a core layer. The first thermoplastic adhesive layer is made of a first thermoplastic resin. The second thermoplastic adhesive layer is made of a second thermoplastic resin. The core layer has a first surface and a second surface which are opposite to each other, wherein the first surface is bonded to the first thermoplastic adhesive layer, and the second surface is bonded to the second thermoplastic adhesive layer. In addition, the core layer has a plurality of cavities, wherein each of the plurality of cavities has a pore diameter (d) smaller than a thickness (T) of the core layer. The first thermoplastic resin and the second thermoplastic resin are respectively adapted to be filled in a part of the plurality of cavities adjacent to the first surface of the core layer and a part of the plurality of cavities adjacent to the second surface of the core layer by heating.

In one embodiment of the present disclosure, in a second state after the first thermoplastic adhesive layer and the second thermoplastic adhesive layer are heated, a part or all of the first thermoplastic resin of the first thermoplastic adhesive layer is filled in a part of the plurality of cavities located in the first surface of the core layer to form a first filling part; and a part or all of the second thermoplastic resin of the second thermoplastic adhesive layer is filled in a part of the plurality of cavities located in the second surface of the core layer to form a second filling part.

In one embodiment of the present disclosure, in a first state before the first thermoplastic adhesive layer and the second thermoplastic adhesive layer are heated, one of the first thermoplastic adhesive layer and the second thermoplastic adhesive layer is connected with the core layer to form a first boundary line, wherein the first boundary line has a first length (L1). In the second state after the first thermoplastic adhesive layer and the second thermoplastic adhesive layer are heated, the first filling part or the second filling part is connected with the core layer to form a second boundary line, and the second boundary line has a second length (L2). The ratio (L2/L1) of the second length (L2) to the first length (L1) is greater than 1.05.

In one embodiment of the present disclosure, the pore diameter (d) of each of the plurality of cavities is 0.05-0.5 mm.

In one embodiment of the present disclosure, the thickness of the core layer is 0.1-1.5 mm.

In one embodiment of the present disclosure, the density of the core layer is 0.003-1 g/cm³.

In one embodiment of the present disclosure, the core layer contains a synthetic substance of acrylonitrile and methacrylic acid, polymethacrylimide (PMI), polyvinyl chloride (PVC), polystyrene (PS), polyurethane (PUR), acrylonitrile-styrene copolymer (SAN), polyetherimide (PEI), polypropylene (PP) or a combination thereof.

In one embodiment of the present disclosure, the flow temperatures of the first thermoplastic resin and the second thermoplastic resin are 65° C.−180° C.

In one embodiment of the present disclosure, the melting indexes of the first thermoplastic resin and the second thermoplastic resin are 6 g/10 min to 15 g/10 min.

In one embodiment of the present disclosure, the thicknesses of the first thermoplastic adhesive layer and the second thermoplastic adhesive layer are 0.01-0.3 mm.

In one embodiment of the present disclosure, each of the first thermoplastic resin and the second thermoplastic resin contains polycaprolactone (PCL), polyether polyol, polyurethane (PU) or a combination thereof.

In one embodiment of the present disclosure, the composite material further comprises a first resin-impregnated layer and a second resin-impregnated layer. The first resin-impregnated layer and the second resin-impregnated layer are respectively arranged at two sides of a laminated body composed of the first thermoplastic adhesive layer, the core layer and the second thermoplastic adhesive layer, wherein the first thermoplastic adhesive layer is located between the first resin-impregnated layer and the core layer, and the second thermoplastic adhesive layer is located between the second resin-impregnated layer and the core layer.

The present disclosure further provides a manufacturing method of a composite material, and the manufacturing method comprises: providing a first thermoplastic adhesive layer made of a first thermoplastic resin and a second thermoplastic adhesive layer made of a second thermoplastic resin; and respectively arranging the first thermoplastic adhesive layer and the second thermoplastic adhesive layer at two sides of a core layer having a first surface and a second surface which are opposite to each other to ensure that the first surface of the core layer is bonded to the first thermoplastic adhesive layer, and the second surface of the core layer is bonded to the second thermoplastic adhesive layer. In addition, the core layer has a plurality of cavities, wherein each of the plurality of cavities has a pore diameter (d) smaller than a thickness (T) of the core layer. The first thermoplastic resin and the second thermoplastic resin are respectively adapted to be filled in a part of the plurality of cavities adjacent to the first surface of the core layer and a part of the plurality of cavities adjacent to the second surface of the core layer by heating.

In one embodiment of the present disclosure, the manufacturing method of the composite material further comprises: heating the first thermoplastic adhesive layer and the second thermoplastic adhesive layer to make the composite material be in a second state. In the second state, a part or all of the first thermoplastic resin of the first thermoplastic adhesive layer is filled in a part of the plurality of cavities located in the first surface of the core layer to form a first filling part. In addition, a part or all of the second thermoplastic resin of the second thermoplastic adhesive layer is filled in a part of the plurality of cavities located in the second surface of the core layer to form a second filling part.

In one embodiment of the present disclosure, the manufacturing method of the composite material further comprises: respectively arranging the first resin-impregnated layer and the second resin-impregnated layer at two sides of the laminated body composed of the core layer, the first thermoplastic adhesive layer and the second thermoplastic adhesive layer to ensure that the first thermoplastic adhesive layer is located between the first resin-impregnated layer and the core layer, and the second thermoplastic adhesive layer is located between the second resin-impregnated layer and the core layer.

The present disclosure further provides an electronic device comprising a body and a casing covering the body, wherein the casing is a composite material or a composite material manufactured by using a manufacturing method of the composite material.

Based on the above, the present disclosure provides the composite material and the manufacturing method thereof, and the electronic device, wherein the first thermoplastic resin and the second thermoplastic resin in the composite material are respectively adapted to be filled in a part of the plurality of cavities adjacent to the first surface of the core layer and a part of the plurality of cavities adjacent to the second surface of the core layer by heating, so that the first thermoplastic adhesive layer and the second thermoplastic adhesive layer are respectively tightly gripped together with the core layer, and furthermore, the composite material shows excellent mechanical strength. In addition, the core layer has the plurality of cavities, so that the composite material has relatively low density compared with a material without cavities, and furthermore, the effect of lightweight is achieved after the core layer is combined with the first thermoplastic adhesive layer and the second thermoplastic adhesive layer. In addition, due to the use of the thermoplastic material, the composite material also has the characteristic of easy recovery, and therefore, the aim of environment protection is achieved.

In order to make the aforementioned and other objectives and advantages of the present disclosure comprehensible, embodiments accompanied with figures are described in detail below.

### BRIEF DESCRIPTION OF THE DRAWINGS

FIG. 1 is a schematic diagram of a cross section of a first state of a composite material according to one embodiment of the present disclosure.

FIG. 2 is a schematic diagram of a cross section of a second state of the composite material according to one embodiment of the present disclosure.

FIG. 3 is an OM image of the cross section of the second state of the composite material according to one embodiment of the present disclosure.

FIG. 4A to FIG. 4C are schematic diagram of a cross section of a manufacturing process of the composite material according to one embodiment of the present disclosure.

### DESCRIPTION OF THE EMBODIMENTS

Hereinafter, a ‘first state’ is a state before a first thermoplastic adhesive layer and a second thermoplastic adhesive layer which are mentioned below are heated. A ‘second state’ is a state after the first thermoplastic adhesive layer and the second thermoplastic adhesive layer are heated.

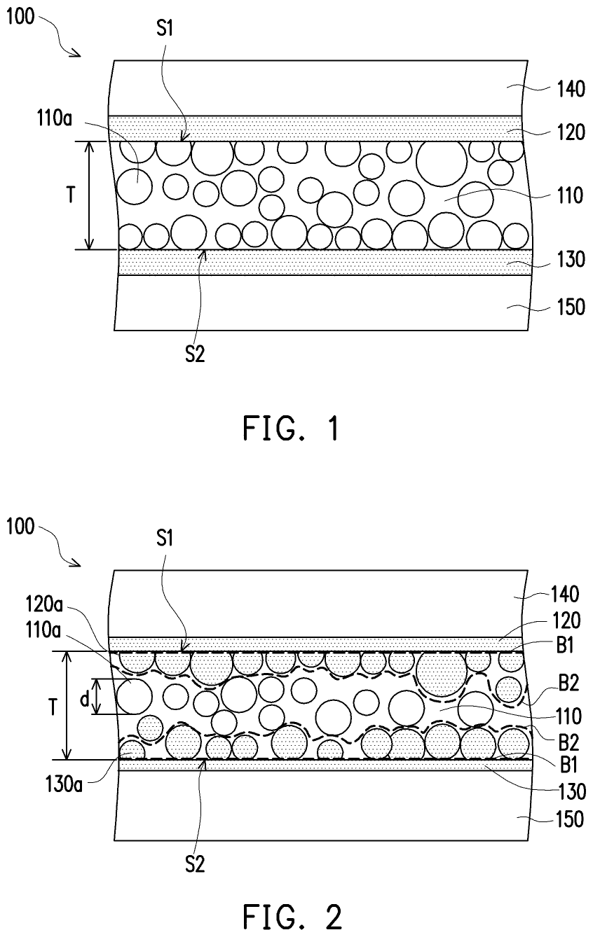

FIG. 1 is a schematic diagram of a cross section of a first state of a composite material according to one embodiment of the present disclosure.

Referring to FIG. 1, a composite material 100 includes a core layer 110, a first thermoplastic adhesive layer 120 and a second thermoplastic adhesive layer 130. The core layer 110 has a first surface S1 and a second surface S2 which are opposite to each other. The first surface S1 of the core layer 110 is bonded to the first thermoplastic adhesive layer 120, and the second surface S2 of the core layer 110 is bonded to the second thermoplastic adhesive layer 130.

In addition, as shown in FIG. 1, the composite material 100 further includes a first resin-impregnated layer 140 and a second resin-impregnated layer 150. The first resin-impregnated layer 140 and the second resin-impregnated layer 150 are respectively arranged at two sides of a laminated body composed of the core layer 110, the first thermoplastic adhesive layer 120 and the second thermoplastic adhesive layer 130. Furthermore, as shown in FIG. 1, the first thermoplastic adhesive layer 120 is located between the first resin-impregnated layer 140 and the core layer 110, and the second thermoplastic adhesive layer 130 is located between the second resin-impregnated layer 150 and the core layer 110.

The core layer 110 has a plurality of cavities 110a, so that the composite material 100 has relatively low density compared with a material without cavities 110a, and furthermore, the effect of lightweight is achieved after the core layer 110 is combined with the first thermoplastic adhesive layer 120 and the second thermoplastic adhesive layer 130. The cavities 110a are not specially limited on shapes such as rounds, ovals, rectangles, polygons or irregular shapes. Each of the plurality of cavities 110a is a mutually-independent air chamber, namely any two or more adjacent cavities 110a cannot overlap with each other. The cavities 110a in the first surface S1 and the cavities 110a in the second surface S2 are communicated with the adjacent cavities 110a or the inside cavities 110a in a following thermal bonding process to form pits with irregular shapes. A pore diameter d of each of the plurality of cavities 110a is smaller than a thickness T of the core layer 110. The pore diameter d of each of the plurality of cavities 110a is 0.05-0.5 mm. When the pore diameter d is within the range, the physical combination property of the first thermoplastic adhesive layer 120, the second thermoplastic adhesive layer 130 and the core layer 110 is good, and therefore, the composite material shows more excellent mechanical strength.

The core layer 110 is polymer foam, preferably, low-density closed porous foam. Furthermore, a material for making the core layer 110 contains a synthetic substance of acrylonitrile and methacrylic acid, polymethacrylimide (PMI), polyvinyl chloride (PVC), polystyrene (PS), polyurethane (PUR), acrylonitrile-styrene copolymer (SAN), polyetherimide (PEI), polypropylene (PP) or a combination thereof. In order to meet the demand for manufacturing a thin electronic device, the thickness of the core layer 110 is preferably 0.1-1.5 mm, and the density of the core layer 110 is 0.003-1 g/cm³. Thus, in the view of improving the mechanical strength of the composite material 100, the material for making the core layer 110 is preferably PMI (the density is 0.075 g/cm³).

The first thermoplastic adhesive layer 120 is made of a first thermoplastic resin. The second thermoplastic adhesive layer 130 is made of a second thermoplastic resin.

It should be noted that the first thermoplastic resin and the second thermoplastic resin do not have adhesiveness and flowability before being heated, but have the adhesiveness and flowability after being heated, namely the first thermoplastic resin and the second thermoplastic resin are converted from a solid state to a liquid state after being heated. Therefore, the first thermoplastic resin and the second thermoplastic resin respectively enter a part of the plurality of cavities 110a located in the first surface S1 of the core layer 110 and a part of the plurality of cavities 110a located in the second surface S2 of the core layer 110 after being heated. In other words, the first thermoplastic resin and the second thermoplastic resin are respectively adapted to be filled in a part of the plurality of cavities 110a adjacent to the first surface S1 of the core layer 110 and a part of the plurality of cavities 110a adjacent to the second surface S2 of the core layer 110 by heating. Therefore, the first thermoplastic adhesive layer 120 and the second thermoplastic adhesive layer 130 are respectively tightly gripped together with the core layer 110. In the microscopic view, the first thermoplastic resin and the second thermoplastic resin are also chemically combined with the core layer 110 in addition to being physically bonded with the core layer 110. Thus, the composite material 100 shows excellent mechanical strength due to tight internal combination of the composite material 100 including the first thermoplastic adhesive layer 120, the second thermoplastic adhesive layer 130 and the core layer 110.

In addition, the first thermoplastic resin and the second thermoplastic resin are preferably adapted to be filled in a part of the plurality of cavities 110a adjacent to the first surface S1 of the core layer 110 and a part of the plurality of cavities 110a adjacent to the second surface S2 of the core layer 110 by heating and pressurizing in addition to adaption to be filled in a part of the plurality of cavities 110a adjacent to the first surface S1 of the core layer 110 and a part of the plurality of cavities 110a adjacent to the second surface S2 of the core layer 110 by heating. Thus, the first thermoplastic adhesive layer 120 and the second thermoplastic adhesive layer 130 are respectively tightly gripped together with the core layer 110, so that the composite material shows more excellent mechanical strength.

The flow temperatures of the first thermoplastic resin and the second thermoplastic resin are 65-180° C. When the flow temperatures are in the range, the first thermoplastic resin and the second thermoplastic resin meet the demands for adhesiveness and flowability after being heated. The melting indexes of the first thermoplastic resin and the second thermoplastic resin are 6 g/10 min to 15 g/10 min. When the melting indexes are in the range, the first thermoplastic resin and the second thermoplastic resin meet the demands for adhesiveness and flowability after being heated.

Moreover, the composite material 100 is made of the thermoplastic resin which is adapted to shaping so as to be applied to a side wall of a casing mentioned below. Therefore, the thermoplastic resin is combined with a first resin-impregnated layer 140 and a second resin-impregnated layer 150 which are mentioned below, so that the composite material 100 shows excellent mechanical strength.

In addition, in a first state before the first thermoplastic adhesive layer 120 and the second thermoplastic adhesive layer 130 are heated, the first thermoplastic adhesive layer 120 is only bonded to the first surface S1 of the core layer 110, the second thermoplastic adhesive layer 130 is only bonded to the second surface S2 of the core layer 110, and thus, a first filling part 120a and a second filling part 130a which are mentioned below are not formed.

Each of the first thermoplastic resin and the second thermoplastic resin contains polycaprolactone (PCL), polyether polyol, polyurethane (PU) or a combination thereof. In the view of improving the mechanical strength of the composite material 100, the first thermoplastic resin and the second thermoplastic resin are preferably polyurethane.

The thicknesses of the first thermoplastic adhesive layer 120 and the second thermoplastic adhesive layer 130 are 0.01-0.3 mm, preferably 0.10-0.20 mm, more preferably 0.10 mm. When the thicknesses of the first thermoplastic adhesive layer 120 and the second thermoplastic adhesive layer 130 are 0.10-0.20 mm, it is not easy for the first thermoplastic adhesive layer 120 and the second thermoplastic adhesive layer 130 to be separated (stripped) from the core layer 110.

Each of the first resin-impregnated layer 140 and the second resin-impregnated layer 150 includes resin and a fiber material, wherein the resin is impregnated in the fiber material.

The resin is polycarbonate (PC), a mixture of polycarbonate/acrylonitrile-butadiene-styrene (PC/ABS), polypropylene (PP), polyphenylene sulfide (PPS), polyetheretherketone (PEEK) and poly(ether sulfones) (PES). The fiber material is carbon fiber, glass fiber, Kevlar fiber, basalt fiber, artificial fiber, or natural fiber or composite fiber of a combination thereof. A fiber weaving manner of the fiber material is unidirectional fiber or woven fiber.

The resin contained in the first resin-impregnated layer 140 and the second resin-impregnated layer 150 preferably mutually has an adhesive force with the first thermoplastic resin or the second thermoplastic resin, so that the first resin-impregnated layer 140 and the second resin-impregnated layer 150 are respectively stably combined with the first thermoplastic adhesive layer 120 and the second thermoplastic adhesive layer 130. For example, polycarbonate (PC) is selected, different fiber materials are matched, while the first thermoplastic resin or the second thermoplastic preferably selects a thermoplastic resin mutually having an adhesive force with PC. In one embodiment, the first resin-impregnated layer 140 and the second resin-impregnated layer 150 are resin-impregnated layers formed by impregnating PC into the carbon fiber.

In one embodiment, the composite material 100 more preferably takes polymethacrylimide as the core layer 110, polyurethane as the first thermoplastic resin and the second thermoplastic resin and a material manufactured by taking the polycarbonate-impregnated carbon fiber (such as unidirectional (UD) carbon fiber cloth) as a fiber material as the first resin-impregnated layer 140 and the second resin-impregnated layer 150. When the aforementioned material combination is used, the composite material 100 achieves relatively high mechanical strength.

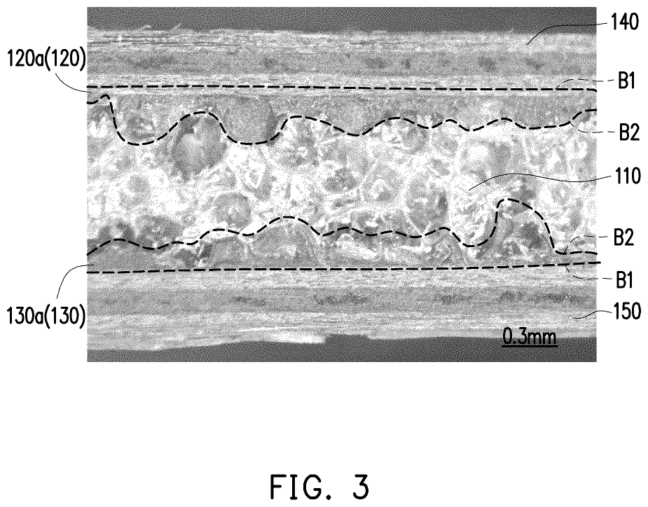

FIG. 2 is a schematic diagram of a cross section of a second state of the composite material 100 according to one embodiment of the present disclosure.

In a second state after the first thermoplastic adhesive layer 120 and the second thermoplastic adhesive layer 130 are heated, a part or all of the first thermoplastic resin of the first thermoplastic adhesive layer 120 is filled in a part of the plurality of cavities 110a located in the first surface S1 of the core layer 110 to form a first filling part 120a. In other words, the first thermoplastic resin, adjacent to the first surface S1 of the core layer 110, of the first thermoplastic adhesive layer 120 flows into a part of the plurality of cavities 110a located in the first surface S1 of the core layer 110 after being heated, thereby forming an overlapped part where the first thermoplastic adhesive layer 120 is tightly gripped with the core layer 110 on the first surface S1 of the core layer 110, and the part is called the first filling part 120a. It should be noted that the first thermoplastic adhesive layer 120 is connected with the core layer 110 by the first filling part 120a if a part of the first thermoplastic resin is filled in a part of the plurality of cavities 110a located in the first surface S1 of the core layer 110. Almost all the resin contained in the first thermoplastic adhesive layer 120 becomes the first filling part 120a if all of the first thermoplastic resin is filled in a part of the plurality of cavities 110a located in the first surface S1 of the core layer 110.

In addition, in the second state, a part or all of the second thermoplastic resin of the second thermoplastic adhesive layer 130 is filled in a part of the plurality of cavities 110a located in the second surface S2 of the core layer 110 to form a second filling part 130a. In other words, the second thermoplastic resin, adjacent to the second surface S2 of the core layer 110, of the second thermoplastic adhesive layer 130 flows into a part of the plurality of cavities 110a located in the second surface S2 of the core layer 110 after being heated, thereby forming an overlapped part where the second thermoplastic adhesive layer 130 is tightly gripped with the core layer 110 on the second surface S2 of the core layer 110, and the part is called the second filling part 130a. Herein, the first thermoplastic adhesive layer 120 and the second thermoplastic adhesive layer 130 are respectively tightly combined with the core layer 110 by the first filling part 120a and the second filling part 130a, so that the composite material 100 shows excellent mechanical strength. It should be noted that the second thermoplastic adhesive layer 130 is connected with the core layer 110 by the second filling part 130a if a part of the second thermoplastic resin is filled in a part of the plurality of cavities 110a located in the second surface S2 of the core layer 110. Almost all the resin contained in the second thermoplastic adhesive layer 130 becomes the second filling part 130a if all of the second thermoplastic resin is filled in a part of the plurality of cavities 110a located in the second surface S2 of the core layer 110.

In one embodiment, in a first state before the first thermoplastic adhesive layer 120 and the second thermoplastic adhesive layer 130 are heated, one of the first thermoplastic adhesive layer 120 and the second thermoplastic adhesive layer 130 is connected with the core layer 110 to form a first boundary line B1. In the second state after the first thermoplastic adhesive layer 120 and the second thermoplastic adhesive layer 130 are heated, the first filling part 120a or the second filling part 130a is connected with the core layer 110 to form a second boundary line B2. More specifically, orthographic projections of two endpoints of the first boundary line Bland orthographic projections of two endpoints of the second boundary line B2 on the first surface S1 or the second surface S2 of the core layer 110 are mutually overlapped. The first boundary line B1 has a first length (L1). The second boundary line B2 has a second length (L2). The ratio (L2/L1) of the second length (L2) to the first length (L1) is greater than 1.05. Each of the first thermoplastic adhesive layer 120 and the second thermoplastic adhesive layer 130 is more tightly combined with the core layer 110 under the condition that the ratio (L2/L1) of the second length (L2) to the first length (L1) is greater than 1.05, and furthermore, the more excellent mechanical strength is achieved.

In one embodiment, the composite material 100 takes polymethacrylimide as the core layer 110, polyurethane as the first thermoplastic resin and the second thermoplastic resin and carbon fiber (a material manufactured by taking polycarbonate as resin and carbon fiber as a fiber material) as the first resin-impregnated layer 140 and the second resin-impregnated layer 150. At the moment, when the thickness of the composite material 100 is 1.2 mm, the density of the composite material 100 is about 0.880 g/cm³ which achieves an extreme lightweight effect.

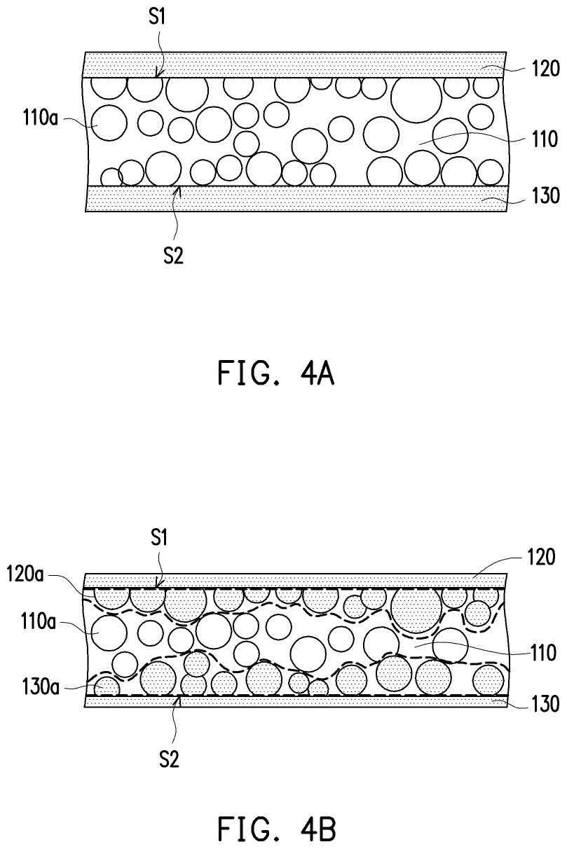

FIG. 3 is an OM image of a cross section of the second state of the composite material 100 according to one embodiment of the present disclosure. In the embodiment, the cross section of the composite material 100 is obtained in a metallographic sectioning way, and the appearance of the cross section of the composite material 100 is observed by using an optical microscope (OM). It can be known from FIG. 3 that the composite material 100 sequentially includes the first resin-impregnated layer 140, the first thermoplastic adhesive layer 120, the core layer 110, the second thermoplastic adhesive layer 130 and the second resin-impregnated layer 150 from top to bottom. It should be noted that most of the first thermoplastic resin in the first thermoplastic adhesive layer 120 has been filled in the plurality of cavities 110a of the core layer 110 to form the first filling part 120a. In the same way, most of the second thermoplastic resin in the second thermoplastic adhesive layer 130 has been filled in the plurality of cavities 110a of the core layer 110 to form the second filling part 130a.

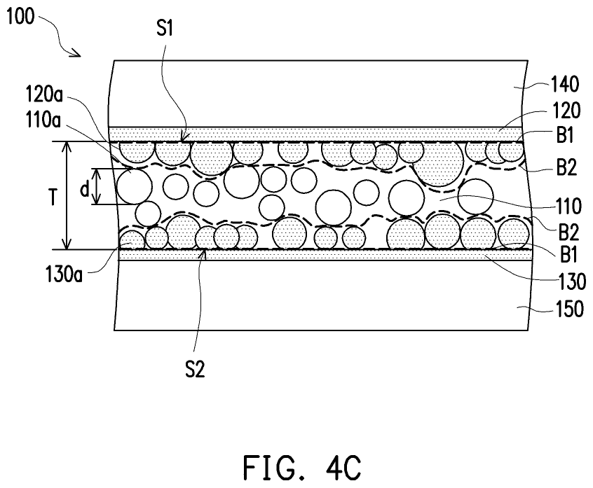

FIG. 4A to FIG. 4C are schematic diagrams of a cross section of a manufacturing process of the composite material 100 according to one embodiment of the present disclosure.

Referring to FIG. 4A, firstly, the first thermoplastic adhesive layer 120 and the second thermoplastic adhesive layer 130 are provided. Then, the first thermoplastic adhesive layer 120 and the second thermoplastic adhesive layer 130 are respectively arranged in parallel at two sides of a core layer 110. The core layer 110 has a first surface S1 and a second surface S2 which are opposite to each other. The first surface S1 of the core layer 110 is bonded to the first thermoplastic adhesive layer 120, and the second surface S2 of the core layer 110 is bonded to the second thermoplastic adhesive layer 130. Herein, the thicknesses, materials and properties of the first thermoplastic adhesive layer 120, the core layer 110 and the second thermoplastic adhesive layer 130 are made reference to the description mentioned above and are selected and changed as required, and the descriptions thereof are omitted herein.

Next, referring to FIG. 4B, the first thermoplastic adhesive layer 120 and the second thermoplastic adhesive layer 130 are heated to make the composite material 100 be in a second state. The heating way is not specially limited, preferably, two sides of a laminated body composed of the core layer 110, the first thermoplastic adhesive layer 120 and the second thermoplastic adhesive layer 130 are pressurized and heated in a first thermal bonding process. The temperature of the first thermal bonding process is 80° C. or higher, preferably, 130° C.-150° C. In addition, the pressure of the first thermal bonding process is 2 kg/cm², preferably, 5-15 kg/cm².

In the second state, a part of the first thermoplastic resin of the first thermoplastic adhesive layer 120 is filled in a part or all of the plurality of cavities 110a located in the first surface S1 of the core layer 110 by heating to form the first filling part 120a. In the same way, a part or all of the second thermoplastic resin of the second thermoplastic adhesive layer 130 is filled in a part of the plurality of cavities 110a located in the second surface S2 of the core layer 110 by heating to form the second filling part 130a. Thus, the first thermoplastic adhesive layer 120 and the second thermoplastic adhesive layer 130 are respectively tightly gripped together with the core layer 110. Thus, the composite material 100 shows excellent mechanical strength due to the tight internal combination of the composite material 100 including the first thermoplastic adhesive layer 120, the second thermoplastic adhesive layer 130 and the core layer 110.

Then, referring to FIG. 4C, the first resin-impregnated layer 140 and the second resin-impregnated layer 150 are respectively arranged at two sides of the laminated body composed of the first thermoplastic adhesive layer 120, the core layer 110 and the second thermoplastic adhesive layer 130 to ensure that the first thermoplastic adhesive layer 120 is located between the first resin-impregnated layer 140 and the core layer 110, and the second thermoplastic adhesive layer 130 is located between the second resin-impregnated layer 150 and the core layer 110. Herein, the thicknesses, materials and properties of the first resin-impregnated layer 140 and the second resin-impregnated layer 150 are made reference to the description mentioned above and are selected and changed as required, and the descriptions thereof are omitted herein.

Next, the first resin-impregnated layer 140, the first thermoplastic adhesive layer 120, the core layer 110, the second thermoplastic adhesive layer 130 and the second resin-impregnated layer 150 are heated again, so that the laminated body composed of the first resin-impregnated layer 140, the first thermoplastic adhesive layer 120, the core layer 110 and the second thermoplastic adhesive layer 130 is adhered to the second resin-impregnated layer 150. The heating way is not specially limited, preferably, the first resin-impregnated layer 140, the laminated body composed of the first thermoplastic adhesive layer 120, the core layer 110 and the second thermoplastic adhesive layer 130 and the second resin-impregnated layer 150 are pressurized and heated by a second thermal bonding process. Parameter conditions of the second thermal bonding process is the same as those of the first thermal bonding process, and the descriptions thereof are omitted herein.

In other embodiments, the first thermal bonding process is also omitted, and the first resin-impregnated layer 140, the first thermoplastic adhesive layer 120, the core layer 110, the second thermoplastic adhesive layer 130 and the second resin-impregnated layer 150 are directly stacked together and are pressurized and heated by a thermal bonding process. Thus, the composite material 100 is manufactured by a single thermal bonding process, so that the effect of simplifying the process is achieved.

In one embodiment, the composite material 100 or a composite material 100 manufactured by using the manufacturing method of the composite material 100 is applied to a casing of an electronic device. In detail, the electronic device includes a body and a casing covering the body, wherein the casing is made by the composite material 100. In addition, the outer surface of the casing is subjected to treatment such as paint spraying and out-mold release (OMR) according to the demands for the appearance.

The electronic device is not specially limited and is, for example, a desktop computer, a notebook computer, a tablet personal computer, a smartphone, a personal digital assistant and an electronic book. In the view of lightweight and durability, the characteristic of the composite material 100 is relatively sufficiently exerted if the composite material 100 is applied to a portable electronic device.

Based on the above, the present disclosure provides the composite material and the manufacturing method thereof, and the composite material is adapted to the electronic device. The first thermoplastic resin and the second thermoplastic resin in the composite material do not have adhesiveness and flowability before being heated, but have the adhesiveness and flowability after being heated. Therefore, the first thermoplastic resin and the second thermoplastic resin are filled in a part of the plurality of cavities adjacent to the first surface of the core layer and a part of the plurality of cavities adjacent to the second surface of the core layer after being heated, and furthermore, the first thermoplastic adhesive layer and the second thermoplastic adhesive layer are respectively tightly gripped together with the core layer. Thus, the composite material shows excellent mechanical strength due to tight internal combination of the composite material including the first thermoplastic adhesive layer, the second thermoplastic adhesive layer and the core layer. In addition, the core layer has the plurality of cavities, so that the composite material has relatively low density compared with a material without cavities, and furthermore, the effect of lightweight is achieved after the core layer is combined with the first thermoplastic adhesive layer and the second thermoplastic adhesive layer. In addition, due to the use of the thermoplastic material, the composite material also has the characteristic of simple recovery, and therefore, the aim of environment protection is achieved.

Although the disclosure is described with reference to the above embodiments, the embodiments are not intended to limit the disclosure. A person of ordinary skill in the art may make variations and modifications without departing from the spirit and scope of the disclosure. Therefore, the protection scope of the disclosure should be subject to the appended claims.

What is claimed is:

1. A composite material, comprising:
a first thermoplastic adhesive layer, formed of a first thermoplastic resin;
a second thermoplastic adhesive layer, formed of a second thermoplastic resin;
a core layer, having a first surface and a second surface which are opposite to each other, wherein the first surface is bonded to the first thermoplastic adhesive layer, and the second surface is bonded to the second thermoplastic adhesive layer,
wherein the core layer has a plurality of cavities, each of the plurality of cavities has a pore diameter (d) smaller than a thickness (T) of the core layer,
the first thermoplastic resin and the second thermoplastic resin are respectively adapted to be filled in a part of the plurality of cavities adjacent to the first surface of the core layer and a part of the plurality of cavities adjacent to the second surface of the core layer by heating.

2. The composite material according to claim 1, wherein in a second state after the first thermoplastic adhesive layer and the second thermoplastic adhesive layer are heated,
a part or all of the first thermoplastic resin of the first thermoplastic adhesive layer is filled in a part of the plurality of cavities located in the first surface of the core layer to form a first filling part, and
a part or all of the second thermoplastic resin of the second thermoplastic adhesive layer is filled in a part of the plurality of cavities located in the second surface of the core layer to form a second filling part.

3. The composite material according to claim 2, wherein in a first state before the first thermoplastic adhesive layer and the second thermoplastic adhesive layer are heated, one of the first thermoplastic adhesive layer and the second thermoplastic adhesive layer is connected with the core layer to form a first boundary line, and the first boundary line has a first length (L1),
in the second state after the first thermoplastic adhesive layer and the second thermoplastic adhesive layer are heated, the first filling part or the second filling part is connected with the core layer to form a second boundary line, and the second boundary line has a second length (L2),
wherein a ratio (L2/L1) of the second length (L2) to the first length (L1) is greater than 1.05.

4. The composite material according to claim 1, wherein the pore diameter (d) of each of the plurality of cavities is 0.05-0.5 mm.

5. The composite material according to claim 1, wherein the thickness of the core layer is 0.1-1.5 mm.

6. The composite material according to claim 1, wherein a density of the core layer is 0.003-1 g/cm³.

7. The composite material according to claim 1, wherein the core layer comprises a synthetic substance of acrylonitrile and methacrylic acid, polymethacrylimide (PMI), polyvinyl chloride (PVC), polystyrene (PS), polyurethane (PUR), acrylonitrile-styrene copolymer (SAN), polyetherimide (PEI), polypropylene (PP) or a combination thereof.

8. The composite material according to claim 1, wherein flow temperatures of the first thermoplastic resin and the second thermoplastic resin are 65° C.−180° C.

9. The composite material according to claim 1, wherein melting indexes (MI) of the first thermoplastic resin and the second thermoplastic resin are 6 g/10 min to 15 g/10 min.

10. The composite material according to claim 1, wherein thicknesses of the first thermoplastic adhesive layer and the second thermoplastic adhesive layer are 0.01-0.3 mm.

11. The composite material according to claim 1, wherein the first thermoplastic resin and the second thermoplastic resin respectively comprise polycaprolactone (PCL), polyether polyol, polyurethane (PU) or a combination thereof.

12. The composite material according to claim 1, further comprising a first resin-impregnated layer and a second resin-impregnated layer which are respectively arranged at two sides of a laminated body formed by the core layer, the first thermoplastic adhesive layer and the second thermoplastic adhesive layer, wherein the first thermoplastic adhesive layer is located between the first resin-impregnated layer and the core layer, and the second thermoplastic adhesive layer is located between the second resin-impregnated layer and the core layer.

13. A manufacturing method of a composite material, comprising:
providing a first thermoplastic adhesive layer formed of a first thermoplastic resin and a second thermoplastic adhesive layer formed of a second thermoplastic resin; and
arranging the first thermoplastic adhesive layer and the second thermoplastic adhesive layer respectively at two sides of a core layer having a first surface and a second surface which are opposite to each other such that the first surface of the core layer is bonded to the first thermoplastic adhesive layer, and the second surface of the core layer is bonded to the second thermoplastic adhesive layer,
wherein the core layer has a plurality of cavities, wherein each of the plurality of cavities has a pore diameter (d) smaller than a thickness (T) of the core layer, and
the first thermoplastic resin and the second thermoplastic resin are respectively adapted to be filled in a part of the plurality of cavities adjacent to the first surface of the core layer and a part of the plurality of cavities adjacent to the second surface of the core layer by heating.

14. The manufacturing method of the composite material according to claim 11, further comprising: heating the first thermoplastic adhesive layer and the second thermoplastic adhesive layer to make the composite material be in a second state,
in the second state,
a part or all of the first thermoplastic resin of the first thermoplastic adhesive layer is filled in a part of the plurality of cavities located in the first surface of the core layer to form a first filling part, and
a part or all of the second thermoplastic resin of the second thermoplastic adhesive layer is filled in a part of the plurality of cavities located in the second surface of the core layer to form a second filling part.

15. The manufacturing method of the composite material according to claim 11, wherein in a first state before the first thermoplastic adhesive layer and the second thermoplastic adhesive layer are heated, one of the first thermoplastic adhesive layer and the second thermoplastic adhesive layer is connected with the core layer to form a first boundary line, and the first boundary line has a first length (L1),
in the second state after the first thermoplastic adhesive layer and the second thermoplastic adhesive layer are heated, the first filling part or the second filling part is connected with the core layer to form a second boundary line, and the second boundary line has a second length (L2),
wherein a ratio (L2/L1) of the second length (L2) to the first length (L1) is greater than 1.05.

16. The manufacturing method of the composite material according to claim 11, further comprising: respectively arranging a first resin-impregnated layer and a second resin-impregnated layer at two sides of a laminated body formed of the first thermoplastic adhesive layer, the core layer and the second thermoplastic adhesive layer such that the first thermoplastic adhesive layer is located between the first resin-impregnated layer and the core layer, and the second thermoplastic adhesive layer is located between the second resin-impregnated layer and the core layer.

17. An electronic device, comprising:
a body; and
a casing covering the body, wherein the casing is a composite material as claimed in claim 1.

18. An electronic device, comprising:
a body; and
a casing covering the body, wherein the casing is a composite material manufactured by using the manufacturing method of the composite material as claimed in claim 13.
